(19) United States
(12) Patent Application Publication
(10) Pub. No.: US 2015/0341476 A1
(43) Pub. Date: Nov. 26, 2015

(54) BAND WITH AN ANTENNA FOR USE WITH A WIRELESS ELECTRONIC DEVICE

(71) Applicants: Kenneth HOGUE, Chapel Hill, NC (US); Owen Lewis JOYCE, Cary, NC (US); Timothy NARCHUK, Raleigh, NC (US); Jeffrey LICK, Raleigh, NC (US); Torbjørn ANDERSSEN, Oslo (NO); Sten KIRKBAK, Trondheim (NO); Pål SELNÆS, Morrisville, NC (US); Anders BROMS, Nacka Stockholm (SE); Espen VOLL, Oslo (NO); William Herbert DARDEN, IV, Cary, NC (US); EVADO FILIP HOLDING LTD., London (GB)

(72) Inventors: Kenneth Hogue, Chapel Hill, NC (US); Owen Lewis Joyce, Cary, NC (US); Timothy Bodnarchuk, Raleigh, NC (US); Jeffrey Lick, Raleigh, NC (US); Torbjørn Anderssen, Oslo (NO); Sten Kirkbak, Trondheim (NO); Pål Selnæs, Morrisville, NC (US); Anders Broms, Nacka Stockholm (SE); Espen Voll, Oslo (NO); William Herbert Darden, IV, Cary, NC (US)

(21) Appl. No.: 14/758,993

(22) PCT Filed: Jan. 4, 2013
(86) PCT No.: PCT/US2013/020326

§ 371 Date: Jul. 2, 2015

(51) Int. Cl. H04M 1/02; H04B 1/3827

(52) U.S. Cl. CPC H04M 1/026; H04B 1/385; H04B 2001/3861

(57) ABSTRACT

An electronic device having a unique interface between the electronic circuitry of the device and an antenna that is external to the device and located in a band. The antenna functionality is achieved externally in the band and includes a conductive path from one or more components of the device to the antenna in the band. The conductive path may extend through an exterior housing of the device to electrically connect the one or more components and the antenna.

### FIELD OF THE INVENTION

The present application is directed to an electronic device having an antenna positioned within a band and, more particularly, to aspects of the antenna including connection of the antenna to the device.

### BACKGROUND

Various types of wireless electronic devices are used every day by millions of people throughout the world. These devices generally include communication circuitry that provides for sending and/or receiving signals from a remote source. The devices also include an antenna for sending and receiving the signals.

A drawback of existing devices is their relatively large physical size. This size is necessary to contain the necessary communication circuitry and antenna for providing the wireless communication ability. However, the relatively large size is often a detractor for a user. In some instances, the large size prevents its use in specific contexts. For example, a monitoring device that is worn by person that is being monitored by another may not be feasible if it is too large. The monitored person may simply refuse to wear the device because it is uncomfortable, is not aesthetically pleasing, or some other like reason. A relatively large device may also not be feasible to be worn by a person, but rather require that it be carried with the person.

If a device is reduced in size such that it is feasible to be carried by a person, it may not have the necessary communication capability to be effective. The relative small size may result in an antenna that is not adequate to receive and/or transmit signals in a variety of different contexts. Examples include if the wearer is indoors or in a remote geographic location.

Further complicating the functionality of the antenna used for a body-worn device is the interaction of antenna performance and the human body for small antenna-body separation distances. These radios require antennas that must efficiently operate in order to detect the small RF signals present during communications. However, when the human body is brought in close proximity to the antenna, the bandwidth and overall performance of the antenna typically degrades significantly, negatively affecting the communications performance.

### SUMMARY

The present application is directed to a wireless electronic device that includes an RF antenna positioned in an attached band. The band may be configured to be attached to the user, or to an object that is carried by the user. A unique interface provides for connecting the computational electronics in the device to the external RF antenna. The interface includes a conductive path from the interior of the housing to the antenna in the band. The interface extends through one or more openings in a housing of the device.

One embodiment is directed to a wireless electronic device and includes a wireless communication circuit for sending and receiving wireless signals. An exterior housing extends around the communication circuit, with the housing including an opening. A flexible band is connected to an exterior of the housing in proximity to the opening. The flexible band is configured to attach the device to a user. An antenna positioned in the band and includes antenna traces that extend along a length of the band away from the housing. A conductive element extends through the opening in the housing and is electrically connected to each of the communication circuit and the antenna.

The device may further include a conductive spring contact positioned between the wireless communication circuit and the conductive element. The conductive spring element may be positioned within the housing.

The antenna traces may be mounted on a flexible substrate positioned within an interior of the band.

The device may include a flexible ground member positioned in the band and being connected to a second conductive element that extends through the housing.

The band may further include a seal to prevent water from contacting the conductive element. The seal may include protrusions that extend outward from a bottom side of the band continuously around the conductive element and contact against the exterior of the housing. The seal may also include a rigid backer plate positioned in the band on an opposing side of the antenna from the walls.

The communication circuit and antenna may be configured to operate in an operational band of 850 MHz. The antenna may include an active resonator and a passive resonator to extend the operational bandwidth.

The antenna may be molded into an interior of the band.

The band may include a single-piece construction and may be continuous around an interior opening. The band may further include a receptacle to receive the housing.

Another embodiment is directed to a wireless electronic device that includes a protective casing including an enclosed interior space. A wireless communication circuit for sending and receiving wireless signals is positioned within the enclosed interior space. A band is attached to the protective casing for attaching the device to a user. An antenna is mounted to the band and is positioned away from the protective casing. A ground is mounted to the band and is positioned away from the protective casing. A first conductive element extends through a first opening in the protective casing and electrically connects the wireless communication circuit and the antenna.

The device may also include a second conductive element that extends through a second opening in the protective casing and electrically connects the wireless communication circuit and the ground.

The first conductive element may extend through a portion of the band.

The antenna may extend in proximity to a first side of the band and the ground may extend in proximity to an opposing second side of the band.

At least one opening may extend through the band and may be positioned between the antenna and the ground.

Each of the antenna and the ground may extend along a length of the band away from the housing. The antenna may include a smaller length than the ground.

The band may include a single-piece construction forming an interior section that is continuously surrounded by the band, and the band may include a receptacle to receive the housing.

The protective casing may include a housing constructed of a rigid material and may include a bottom face and lateral sidewalls and a translucent top face that extends between the lateral sidewalls and is spaced away from the bottom face.

Another embodiment is directed to a wireless electronic device and includes a protective casing including opposing first and second faces and a lateral sidewall with the protective casing including an enclosed interior space. A wireless communication circuit for sending and receiving wireless signals is positioned within the enclosed interior space. A flexible band is attached to an exterior of the protective casing. The flexible band includes antenna traces extending away from the protective case along a first side of the band and a ground extending away from the protective case along an opposing second side of the band. A conductive element extends through the protective casing with a first portion extending into the enclosed interior space and a second portion extending outward from the exterior of the protective case. The first portion is configured to electrically connect to the wireless communication circuit and the second portion is configured to electrically connect to the antenna.

The flexible band may include a first section attached to a first side of the protective casing and a second section attached to an opposing second side of the protective band. The flexible band may further include a connector for connecting ends of the first and second sections with the antenna and ground being positioned within one of the first and second sections.

The conductive element may include an elongated pin.

The device may also include a conductive spring contact positioned between the wireless communication circuit and the conductive element. The conductive spring element may be positioned within the enclosed interior space.

The various aspects of the various embodiments may be used alone or in any combination, as is desired.

### BRIEF DESCRIPTION OF THE DRAWINGS

FIG. 1 is a perspective view of a unit including an electronic device and attached band.

FIG. 2 is a schematic diagram of an electronic device.

FIG. 3 is a schematic view of an antenna positioned within a band and positioned relative to an electronic device.

FIG. 4 is a schematic diagram of an antenna.

FIG. 5 is a graph featuring aspects of the antenna illustrated in FIG. 4.

FIG. 6 is a perspective view of an antenna including traces mounted on a flexible printed circuit.

FIG. 7 is a perspective view of an antenna and a ground that form portions of a band.

FIG. 8 is a perspective view of a band.

FIG. 9 is a perspective view of a band with an antenna and a ground illustrated in dashed lines for clarity.

FIG. 10 is a schematic diagram of an antenna and ground positioned with a band.

FIG. 11 is a cut-away view of a band cut along line XI-XI of FIG. 8.

FIG. 12 is a perspective view of a bottom side of band.

FIG. 13 is a perspective view of a band connected to a device housing with an antenna and a ground illustrated in dashed lines for clarity.

FIG. 14 is a sectional view of a pin electrically connecting components in a band and components in the device.

FIG. 15 is a sectional view cut of an electronic device cut along line XIV-XIV of FIG. 13.

FIG. 16 is a perspective view of an electronic device.

FIG. 17 is a perspective view of a unit with a mono-band configuration.

### DETAILED DESCRIPTION

The present application is directed to a band for use with a wireless electronic device. The band is configured to be attached to the electronic device. The band includes an RF antenna to facilitate the wireless communication capabilities of the electronic device. A connection between the antenna in the band and the electronic device may be configured to prevent or reduce water and/or debris from entering into the interior of the device.

In the embodiments illustrated in the drawings, the band is sized and configured to attach to a wrist/arm of a user. However, the band may also be sized and configured for attaching to other locations including but not limited to the user's foot, arm, and leg. Further, the band may be sized and configured to attach to an object other than the user, such as a backpack or some other object carried by the user. The band may also form a handle used for carrying the electronic device.

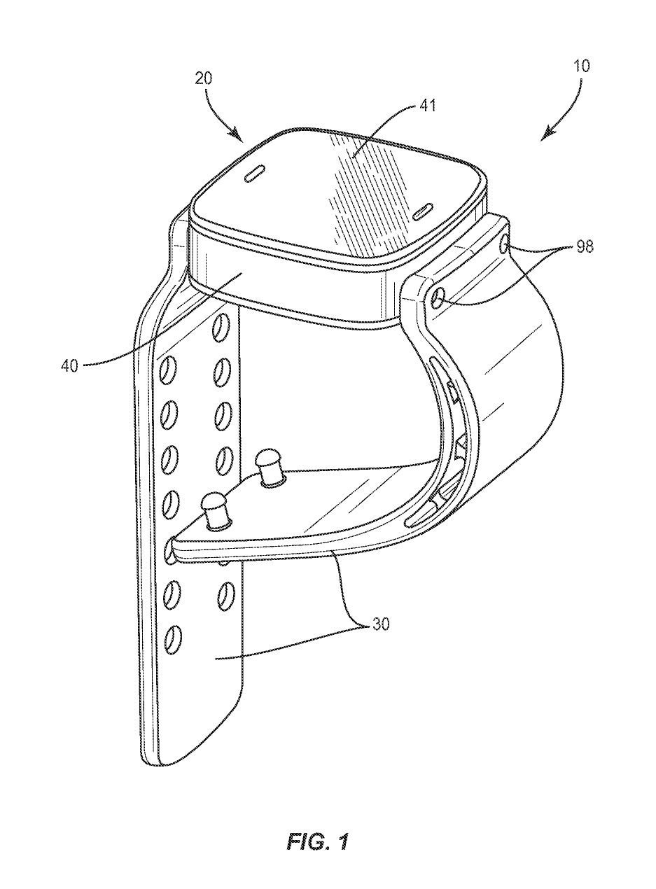

FIG. 1 illustrates a unit 10 configured to be worn by a user. The unit 10 includes a wireless electronic device 20 and a band 30. The device 20 includes a housing 40 that contains wireless communication circuitry for communicating with a remote location. The device 20 is further configured to display information to the user. The band 30 attaches the electronic device 20 to the user. The band 30 may include two or more separate sections that are attached to the device 20 via fasteners 98 as illustrated in FIG. 1. In other embodiments, the band 30 includes a single piece construction with a flexible section that is able to increase in length when the unit 10 is being attached to the user. In the various designs, the overall appearance of the unit 10 is aesthetically pleasing with a sleek design that is attractive to children to thus facilitate its use.

In one embodiment, the unit 20 is configured to monitor the location of a child. The unit 20 is monitored by one or more of a monitoring server and a parent to track the location of the child through the course of the day. The unit 20 further provides for the child to communicate with remotely-located persons, such as a parent.

The exterior of the device 20 is formed by a rigid housing 40 that protects the various internal components. The housing 40 may be constructed from various materials, such as but not limited to various plastics and metals. The housing 40 may include a bottom face and continuous lateral sidewalls. A top face 41 of the unit 20 may be formed by a translucent sheet that is constructed from various materials including glass and plastic that form a portion of a display 22. In one embodiment, the face 41 is GORILLA GLASS. The display 22 is configured to display various alpha-numeric information, video, and various icons to the child.

The housing 40 and top face 41 form a protective exterior that extends around the internal electrical components of the device 20. The interior space formed by the housing 40 and top face 41 may further be design to prevent water or debris from entering to further protect the electrical components.

The device 20 may include various shapes and sizes. In one embodiment as illustrated in FIG. 1, the housing 40 is substantially square with lengths and widths of about 40 mm and a thickness of about 15 mm. In one specific embodiment, the housing includes a length of about 38.9 mm, a width of about 39.8 mm, and a thickness of about 14 mm.

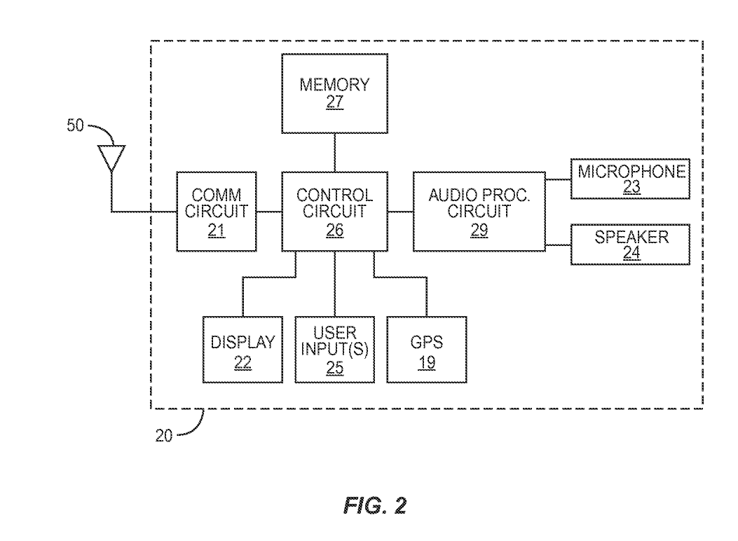

The device 20 is configured to wirelessly communicate with one or more remote parties, such as a monitoring server. FIG. 2 illustrates a block diagram of a child device 20 that includes a control circuit 26 that controls the overall functioning of the device 20. The control circuit 26 may include one or more microprocessors, microcontrollers, Application Specific Integrated Circuits (ASICs), or other programmable devices. The control circuit 26 may be configured to execute program code stored within the device 20 or accessible by the device to control the various components and their functions. For example, the program code may be stored in memory 27, or may be downloaded from a monitoring server. Memory 27 may include one or several types of non-transitory memory, including, for example, read-only memory, flash memory, magnetic or optical storage devices, or the like. In some embodiments, one or more physical memory units may be shared by the various components. Other embodiments may have physically separate memories for one or more of the different components.

A communications circuit 21 provides wireless access to facilitate communication with remote parties. The circuit 21 may include a radio frequency transmitter and receiver for transmitting and receiving signals through an antenna 50. The communications circuit 21 may be further configured to send and receive information through various formats, such as but not limited to SMS text messages and files.

The display 22 provides viewable information for the child, such as the time, source of an incoming call, and the like. The display 22 may comprise various electronic displays, such as a liquid crystal display. One or more input mechanisms 25 may be positioned for controlling the functionality of the device 20. The inputs 25 may include one or more control buttons that are exposed on the exterior of the housing 40. The inputs 25 provide for a user (e.g., the child user or another party) to enter various commands and make menu selections for menus presented on the display 22. The user inputs 25 may also include more intricate devices, such as a keypad, touchpad, and/or a joystick. A global positioning system (GPS) component 19 may be configured to receive coordinate information from various sources (e.g., satellites, base stations) to determine a geographic position of the child device 20.

The child device 20 further includes a microphone 23, speaker 24, and an audio processing circuit 29. The audio processing circuit 29 is configured to provide audio processing functionality for processing voice data for communications through the speaker 23 and microphone 24. FIG. 2 includes separate communication and audio processing circuits 21, 29. One or both of the functionality performed by these circuits 21, 29 may be included within the control circuit 26.

An RF antenna 50 is operatively connected to the communication circuit 21. The antenna 50 may be a dual band antenna configured to operate in the primary mobile communication bands of 850 MHz and 1900 MHz according to the GSM-850 and GSM-1900 standards.

A device that provides for remotely monitoring a child is one example of an electronic device 20. Other examples include but are not limited to a cellular phone, PDA, and a GPS module.

The unit 10 includes a unique interface between the electronic circuitry of the device 20 and the antenna 50 that is external to the device 20 and located in the band 30. For reasons of RF performance, the antenna functionality is achieved externally in the band 30 and includes a conductive path from a printed circuit board (PCB) 28 of the communication circuit 21 to the antenna 50 in the band 30. The conductive path extends through the housing 40 to electrically connect the one or more components and the antenna 50.

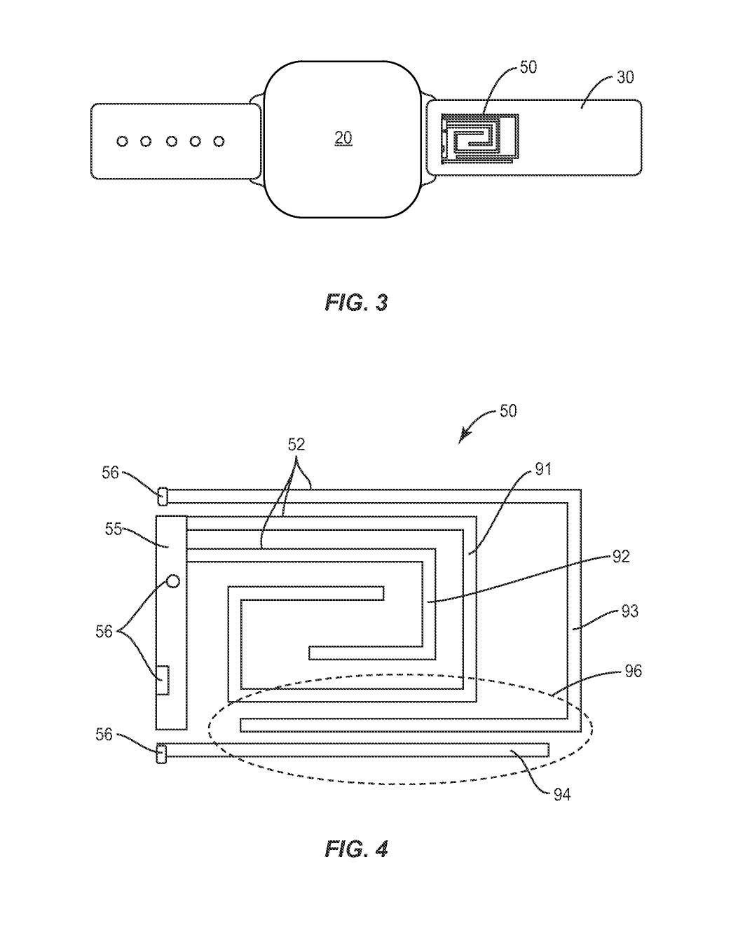

As illustrated in FIG. 3, the antenna 50 is positioned in the band 30 in close proximity to the device 20. This provides for a short distance for interconnection between the antenna 50 and the device 20.

FIG. 4 illustrates one embodiment of an antenna 50 that is positioned in the band 30. The antenna 50 includes antenna traces 52. The traces 52 may be constructed from various conductive materials, such as but not limited to copper. The antenna 50 efficiently operates to detect the small RF signals present during communication, even when brought into close proximity with the human body which occurs when the unit 10 is worn by the user. Historically, when the human body is brought in close proximity to the antenna 50, the bandwidth and overall performance of the antenna typically degrades significantly, negatively affecting the communications performance. The present antenna 50 is designed to maintain the communication performance when the band 30 is worn by the user.

As illustrated in FIG. 4, the antenna 50 includes a main feed trace 55 that connects the antenna 50 to the device 20. There are several ground points 56. The antenna 50 also includes one active resonator 91, 92 for each band of operation. In this embodiment, the antenna 50 is a dual-band antenna and there are two active resonators 91, 92 on the main feed trace 55. The first active resonator 91 includes a length for tuning the impedance match at lower frequencies. The second active resonator 92 includes a length for tuning the impedance match at higher frequencies. The antenna 50 also includes two passive resonators 93, 94 to extend the operational bandwidth. The operational bandwidth of the antenna 50 is the frequency range over which the antenna 50 presents an acceptable impedance match to the radio. A first passive resonator 93 extends the performance in the lower frequencies, and a second passive resonator 94 extends the performance in the higher frequencies.

In one embodiment, the resonators are generally long structures that are generally rectangular in shape with a length much longer than a width. In one embodiment, the ratio of length to width is greater than 25:1. The resonators can be bent or meandered to achieve a compact size. The resonators are placed in close proximity in order for the energy to be efficiently coupled between them. In one embodiment, close proximity between resonators is typically less than 1/100 of a wavelength.

The use of passive resonators to augment operational bandwidth is well known to those knowledgeable in the field of antenna design, especially at higher frequencies. However, the use of passive resonators at lower frequencies has proven to be difficult because of a phenomenon in which the RF energy becomes tightly coupled between the active and passive resonators and cannot radiate into space. As a result, this coupled energy is lost and dissipated as heat. The reason for this loss of energy is the phase relationship between the active and passive resonators is approximately 180 degrees apart over a narrow range of frequencies and the energy is lost through destructive cancellation.

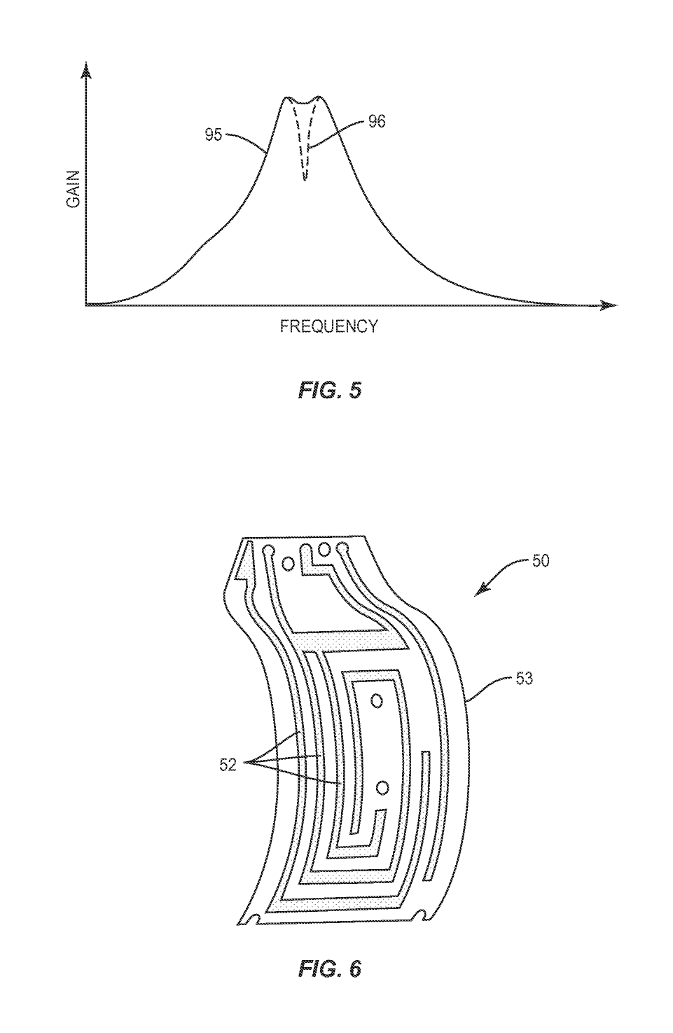

FIG. 5 illustrates this phenomenon where the solid line 95 is the desired gain of the antenna showing the gain increasing over the desired frequency range and then tapering off. In practice, the gain over frequency exhibits a deep null as shown by the dotted line 96 due to the phenomenon of RF energy becoming tightly coupled and lost as heat. This loss of gain prohibits satisfactory operation over the desired frequency range.

The antenna 50 is designed to alter the phase relationship between the active and passive resonators in the lower frequency band so they do not exhibit the 180 degree relationship and so do not suffer the deep null in gain over the desired frequency range. Referring to FIG. 4, the area 96 where the active and passive resonators come in close proximity is highlighted by the dotted line and provides the means to alter the phase relationship. In one embodiment, the resonators are separated by less than about 1/100 of a wavelength. The length and overlap between the active and passive resonators can be varied to adjust the phase relationship over frequency providing increased operational bandwidth of the antenna.

FIG. 6 illustrates another embodiment of the antenna 50 that includes the antenna traces 52. Each of various conductive paths provides for galvanic contact between the electrical components inside the housing 40 and the antenna 50. As such, due to the galvanic nature of the contact, this connection system may be used for a variety of electrical functions, charging, communication, status, etc.

The ground 51 may be connected to the antenna 51 through conductive traces. The conductive traces may be part of a flexible printed circuit (FPC) 53, or as a separate connection.

The antennas 50 may include a flexible printed circuit 53 (FPC) that provides a mount for the antenna traces 52.

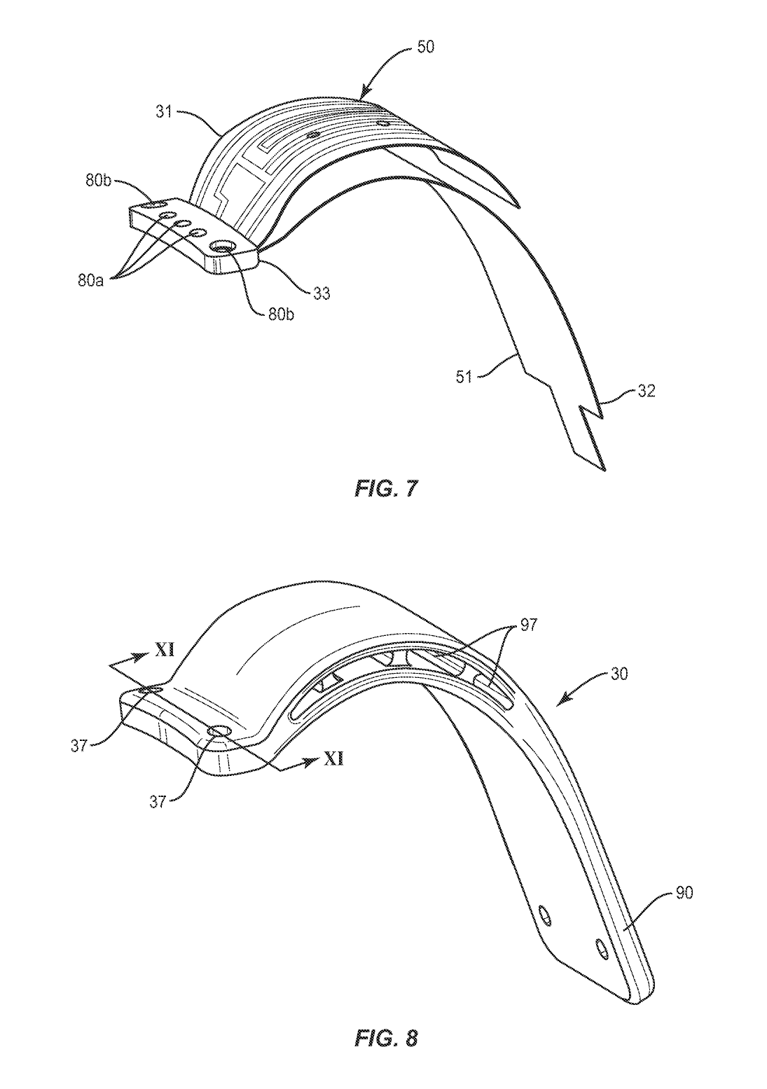

The interior of the band 30 is illustrated in FIG. 7 that includes a first portion 31 with the antenna 50 that includes the flexible printed circuit (FPC) 53 and antenna traces 52. The band 30 also includes a second portion 32 that includes a ground 51. The ground 51 acts to reduce RF absorption into the body and provide a counterpoise for the antenna 50. The ground 51 is constructed from a conductive material. In one embodiment, the ground 51 is constructed of copper. The thickness of the ground 51 may vary. In one embodiment, the thickness is between about 1 mm and about 3 mm. In one specific embodiment, the ground 51 is constructed of copper and is about 1.3 mm thick. In one embodiment, the ground 51 is 0.5 oz.-2.0 oz. copper. In one embodiment, the width of the ground 51 is greater than the FPC 53. In one embodiment, the FPC has a width of about 25 mm-30 mm. The ground 51 may also be longer than the antenna traces 52. In one embodiment, the antenna traces 52 have a length of between about 60 mm-80 mm.

A backer 33 is positioned in the band 30 adjacent to the ends of the first and second portions 31, 32. The backer 33 is a relatively rigid member that provides a structure for attaching the band 30 to the housing 40. The backer 33 includes one or more first openings 80a for electrical connection to the device component, and one or more second openings 80b for receiving fasteners 98 for attachment to the housing 40.

FIG. 8 illustrates the band 30 with a protective outer coating 90 that extends around the backer 33, and first and second portions 31, 32. The band 30 is constructed through a process that includes insert molding the rigid backer 33, the first portion 31, and the second portion 32. This insures that pads on the antenna 50 and the ground 51 are in proper registration with one another and that successive injection over-molding operations will not cause separation of the two layers during the injection molding process.

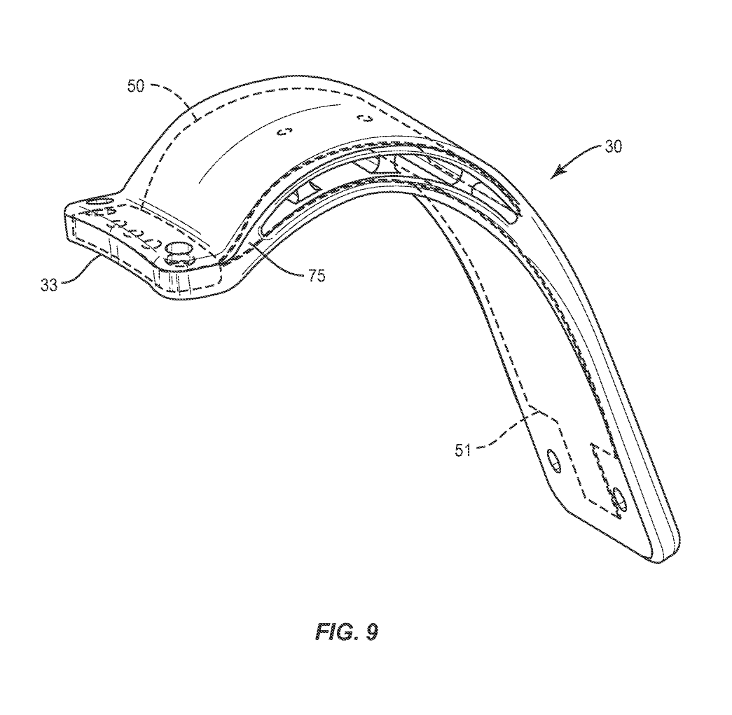

The next steps are multiple over-molding operations to over-mold thermoplastic elastomer (TPE) material that form the protective coating 90 over the antenna 50 and the ground 51. One of the parameters for RF performance is the separation distance between the antenna 50 and the ground 51. The over-molded TPE creates a watertight encapsulation of these layers, and insures that the required separation distance is maintained. The band 30 may include one or more openings 97 that extend through the width. The openings 97 are positioned between the antenna 50 and ground 51 to provide for separation. A low dielectric foam filler material 75 (FIG. 9) may also be positioned between the antenna 50 and ground 51 to provide for electrical isolation. The low dielectric material 75 may also provide sufficient antenna-body separation for proper operation.

As illustrated in FIG. 8, one or more openings 37 extend through the height of the band 30 and align with the openings 80b in the backer 33. The openings 37, 80b are configured to receive the fasteners 98 for attaching the band 30 to the exterior of the housing 40.

FIG. 9 illustrates the positioning of the antenna 50, ground 51, and backer 33 within the interior of the band 30. For purposes of clarity, the band 30 is illustrated in solid lines with the interior components illustrated in dashed lines. The antenna 50 and ground 51 are spaced apart along a length of the band 30. The relative lengths of the antenna 50 and ground 51 may vary. In the embodiment of FIG. 9, the antenna 50 is shorter than the ground 51.

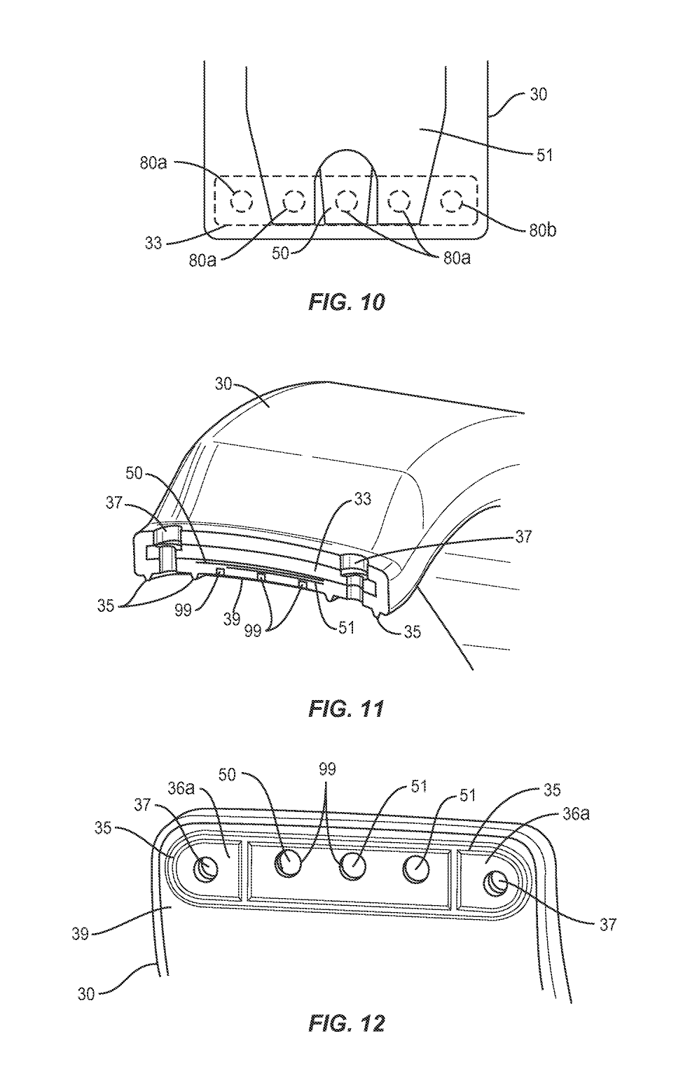

The first ends of the antenna 50 and ground 51 are shaped and/or aligned to contact with one or more conductive pins 61 that extend through the housing 40 and the openings 80a in the band 30. FIG. 10 includes one embodiment of the relative positioning of the antenna 50 and ground 51 for electrical connection to the device 20. This positioning provides for separate connections of the antenna 50 and ground 51 to the device 20. The active elements of the antenna 50 are electrically isolated from the ground 51. In one embodiment, the dielectric material 75 (not illustrated in FIG. 11) may be positioned to provide the isolation.

In one embodiment, the antenna 50 has a generally rectangular shape with dimensions of about 54 mm×about 25 mm. In one embodiment, the ground 51 is has a generally rectangular shape with dimensions of about 89 mm×25 mm.

FIG. 11 includes a sectional view of the band 30 cut through the backer 33 and antenna 50 and ground 51. As illustrated, the antenna 50 and ground 51 are aligned with the backer 33 and the openings 99 that extend into the band 30 from a bottom side 39. The openings 80b in the backer 33 and openings 37 in the band 30 align to receive the fasteners 98. FIG. 12 illustrates a view of the bottom of the band 30 with the antenna 50 and ground 51 aligned with the openings 99. In this embodiment, the ground 51 is aligned with two of the openings 99 and the antenna 50 with the other opening 99. Although the various embodiments have included three connections between the antenna 50 and ground 51 and the device 20, the unit 10 may include various numbers of connections.

The band 30 further includes a seal 34 on the bottom side 39 that engages with the exterior of the housing 40. The seal 34 is constructed from the TPE material that forms the protective exterior coating 90. The seal 34 prevents water and/or debris that may enter through the openings 37/80b from reaching the antenna 50 and ground 51. The seal 34 includes walls 35 that extend outward from the bottom side 39 of the band 30. The walls 35 form different chambers 36 that isolate the antenna 50 and ground 51 from the openings 37/80b. The chambers 36 include a pair of mounting fastener chambers 36a at the openings 37/80b, and an intermediate chamber 36b at the openings 99. When attached to the housing 40, the fasteners 98 that attach the band 30 to the housing 40 apply a compressive force to the rigid backer plate 33 which transfers the load across the interface region. Therefore, the seal 34 is positioned between two rigid materials (the rigid backer plate 33 and the rigid housing 40). The force of the fasteners 98 compresses the seal 34 to provide the watertight interface, and also develops good contact pressure between the conductive pins 61 and the antenna 50 and ground 51.

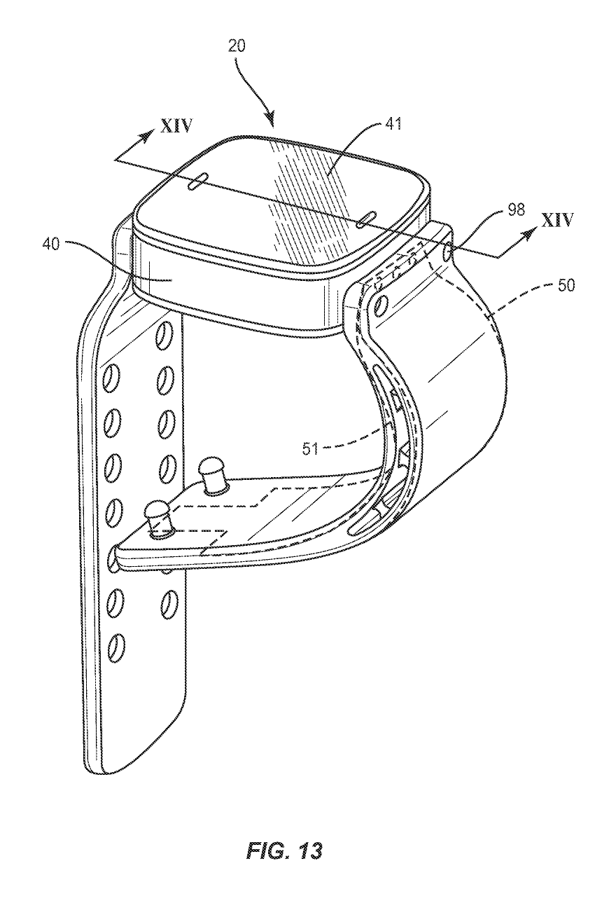

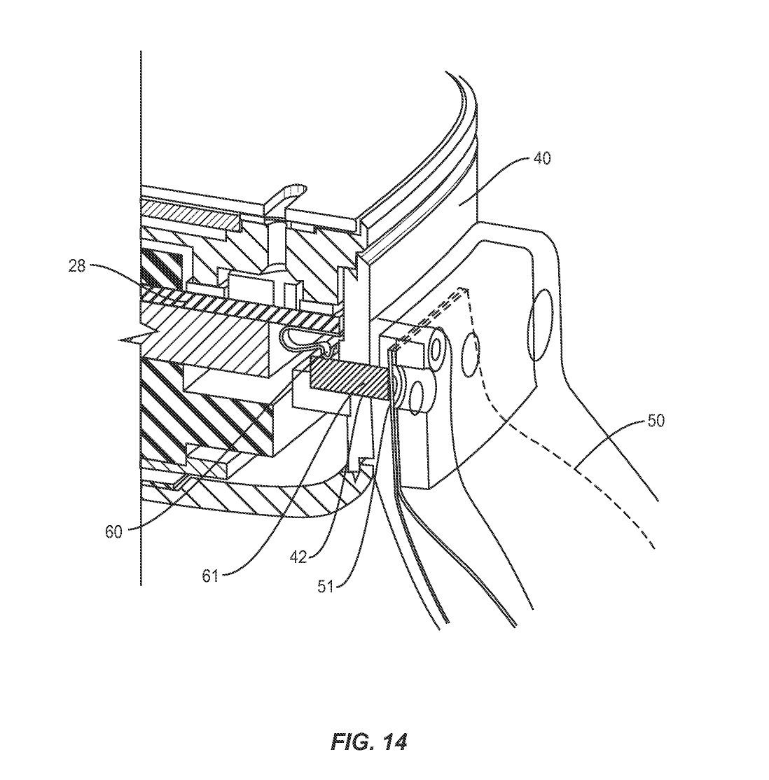

FIGS. 13 and 14 illustrate the band 30 connected to the device 20. For purposes of clarity, the protective covering 90 of the band is illustrated in solid lines and the internal components are illustrated in dashed lines. One or more fasteners 98 extend through the band 30 and attach to the housing 40. This places the bottom side 39 of the band 30 against the housing 40. Further, the housing 40 includes one or more openings 42 to allow for passage of the conductive pins 61. The band 30 is positioned relative to the housing 40 with the openings 42 in the housing 40 being aligned with the openings 80a in the bottom side 39 of the band 30.

FIG. 14 illustrates the connector system that forms a conductive path between the antenna 50/ground 51 located in the band 30 with the one or more electrical components in the device 20. The conductive path consists of a pad on the PCB 28, a conductive spring contact 60 soldered to the PCB 28, and a conductive pin 61 that extends through the opening 42 formed in the housing 40. The conductive pin 61 includes an elongated shape to extend through the opening 42 with a first section contacting with the spring contact 60. The pin 61 further extends through openings in the band 30 and contact against one of the antenna 50 or ground 51. The number of conductive paths that extend between the band 30 and the device 20 may vary. In one embodiment, three pins 61 extend from the device 20 to form the conductive paths.

FIG. 14 includes spring contacts 60 forming a portion of the conductive path. In another embodiment, conductive materials such as a conductive elastomeric material are used instead of the spring contacts 60.

In other embodiments, the gender of the various elements may be reversed. In the embodiment of FIG. 14, the pin 61 is a male element that extends through the housing 40 and mates with one of the antenna 50 and ground 51. Alternatively a male member in the band 30 could mate with the antenna 50 or ground 51 or a female construct on the housing.

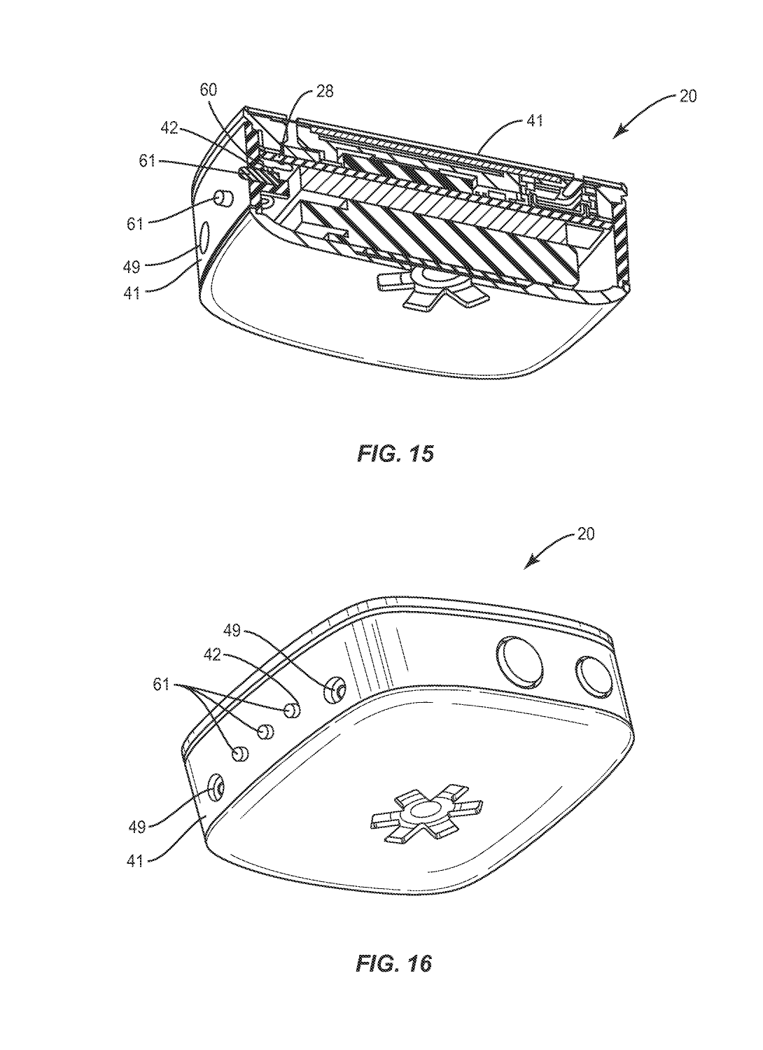

FIGS. 15 and 16 illustrate the device 20 with the conductive pins 61 extending through openings 42 in the housing 41. The band 30 is not illustrated in FIGS. 15 and 16 for clarity. As illustrated, the pins 61 include an elongated shape that extends through the housing 41. A first end of the pins 61 is electrically connected with the contact 60. A second end of the pins 61 extends outward beyond the housing 41 to engage with the antenna 50/ground 51 in the band 30.

With the electronic device 20 as described in FIG. 2, there is a requirement for a Radio Frequency (RF) connection to the antenna 50. The connector system is designed with considerations for a low impedance transition at RF frequencies that will provide maximum bandwidth for the antenna that it feeds. This low impedance is primarily achieved by utilizing an absolute minimum of lead length, coupled with appropriately sized conductor diameters to reduce the series reactance of the system. The antenna traces 52 are in a specific configuration to achieve the appropriate RF signal performance.

Placement of the antenna 50 in the band 30 results in a close physical location with the user during use. The antenna 50 is designed to address the interaction of antenna performance and the human body for small antenna-body separation distances. The antenna design provides good RF efficiency and overall performance while maintaining a small antenna-body separation distance.

There are two areas where antenna performance is degraded with small antenna-body separation: efficiency and bandwidth. Regarding efficiency, the human body readily absorbs RF energy and reduces the signal levels available for detection in a communications link. This band 30 is designed to increase the antenna-body separation and add a conductive shield between the antenna and the body which reduces the amount of RF energy absorbed by the body. These features improve the efficiency of the antenna 50 as well as reduce the specific absorption rate (SAR) into the body.

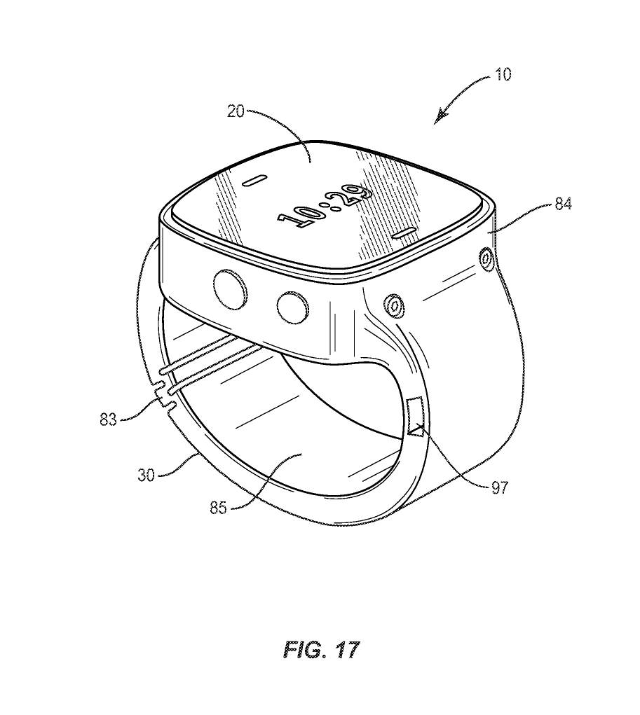

The band 30 may also include a single, mono-construction that includes a single section as illustrated in FIG. 17. The band 30 is a single piece (i.e., it does not include multiple sections with a connection structure) that includes a receptacle portion 84 to receive the electronic device 20. The receptacle portion 84 may be wider than a remainder of the band 30 as illustrated in FIG. 17. The band 30 extends continuously around an interior opening 85.

The mono-band construction is configured to elongate for placing the unit 10 on the user. In one embodiment, the band 30 may be stretched to extend over the hand of the user. Once in position, the band 30 is released and it returns towards and original shape and size to fit around the wrist of the user. In one embodiment, the band 30 includes an inner circumference of about 125 mm. Upon application of an exterior force, the inner circumference increases to about 150 mm.

In one embodiment, the entire band 30 is constructed from a stretchable material to expand the size for attachment to the user. In another embodiment, the band 30 includes a stretch zone area 83 designed to expand in size and then retract towards the original shape and size. The band 30 may be designed such that just the stretch zone 83 can be enlarged (i.e., a remainder of the band 30 is non-stretchable), or may include the stretch zone 83 in combination with a remainder of the band being stretchable (i.e., both the stretch zone 80 and a remainder of the band 30 expand in size). In one embodiment, the stretch zone 83 includes pleats with cuts that extend into the band 30 from opposing sides. The band 30 may be constructed from a variety of different materials, including but not limited to thermoplastic vulcanizates, thermoplastic polyurethane, silicone and other elastomers. The thickness of the stretch zone area 80 may vary. In one embodiment includes a thickness in the area 80 of about 1.5 mm.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A wireless electronic device comprising:
a wireless communication circuit for sending and receiving wireless signals;
an exterior housing that extends around the communication circuit, the housing including an opening;
a flexible band connected to an exterior of the housing in proximity to the opening, the flexible band configured to attach the device to a user;
an antenna positioned in the band, the antenna including antenna traces that extend along a length of the band away from the housing; and
a conductive element that extends through the opening in the housing and is electrically connected to each of the communication circuit and the antenna.

2. The device of claim 1, further comprising a conductive spring contact positioned between the wireless communication circuit and the conductive element, the conductive spring element being positioned within the housing.

3. The device of claim 1, wherein the antenna traces are mounted on a flexible substrate positioned within an interior of the band.

4. The device of claim 1, further comprising a flexible ground member positioned in the band and being connected to a second conductive element that extends through the housing.

5. The device of claim 1, wherein the band further includes a seal to prevent water from contacting the conductive element, the seal including protrusions that extend outward from a bottom side of the band continuously around the conductive element and contact against the exterior of the housing, the seal also including a rigid backer plate positioned in the band on an opposing side of the antenna from the walls.

6. The device of claim 1, wherein the communication circuit and antenna are configured to operate in an operational band of 850 MHz, and the antenna includes an active resonator and a passive resonator to extend the operational bandwidth.

7. The device of claim 1, wherein the antenna is molded into an interior of the band.

8. The device of claim 1, wherein the band includes a single-piece construction and is continuous around an interior opening, the band further includes a receptacle to receive the housing.

9. A wireless electronic device comprising:
a protective casing including an enclosed interior space;
a wireless communication circuit for sending and receiving wireless signals, the wireless communication circuit positioned within the enclosed interior space;
a band attached to the protective casing for attaching the device to a user;
an antenna mounted to the band and is positioned away from the protective casing;
a ground mounted to the band and is positioned away from the protective casing; and
a first conductive element that extends through a first opening in the protective casing and electrically connects the wireless communication circuit and the antenna.

10. The device of claim 9, further comprising a second conductive element that extends through a second opening in the protective casing and electrically connects the wireless communication circuit and the ground.

11. The device of claim 9, wherein the first conductive element extends through a portion of the band.

12. The device of claim 9, wherein the antenna extends in proximity to a first side of the band and the ground extends in proximity to an opposing second side of the band.

13. The device of claim 9, further comprising at least one opening that extends through the band and is positioned between the antenna and the ground.

14. The device of claim 9, wherein each of the antenna and the ground extend along the band away from the housing, wherein the antenna includes a smaller length than the ground.

15. The device of claim 9, wherein the band includes a single-piece construction forming an interior section that is continuously surrounded by the band, the band further including a receptacle to receive the housing.

16. The device of claim 9, wherein the protective casing includes a housing constructed of a rigid material and including a bottom face and lateral sidewalls and a translucent top face that extends between the lateral sidewalls and is spaced away from the bottom face.

17. A wireless electronic device comprising:
a protective casing including opposing first and second faces and a lateral sidewall, the protective casing including an enclosed interior space;
a wireless communication circuit for sending and receiving wireless signals, the wireless communication circuit positioned within the enclosed interior space;
a flexible band attached to an exterior of the protective casing, the flexible band including antenna traces extending away from the protective case along a first side of the band and a ground extending away from the protective case along an opposing second side of the band; and
a conductive element that extends through the protective casing with a first portion extending into the enclosed interior space and a second portion extending outward from the exterior of the protective case, the first portion configured to electrically connect to the wireless communication circuit and the second portion configured to electrically connect to the antenna.

18. The device of claim 17, wherein the flexible band includes a first section attached to a first side of the protective casing and a second section attached to an opposing second side of the protective band, the flexible band further including a connector for connecting ends of the first and second sections, the antenna and ground being positioned within one of the first and second sections.

19. The device of claim 17, wherein the conductive element includes an elongated pin.

20. The device of claim 17, further comprising a conductive spring contact positioned between the wireless communication circuit and the conductive element, the conductive spring element being positioned within the enclosed interior space.
